(19) United States
(12) Patent Application Publication
(10) Pub. No.: US 2007/0084463 A1
(43) Pub. Date: Apr. 19, 2007

(54) Breathing Apparatus

(76) Inventors: Bradley Q. Niemann, Hillsboro, IL (US); Michael Thomas Hill, Swansea, IL (US); Brian Kelley Posey, Edwardsville, IL (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/530,318

(22) Filed: Sep. 8, 2006

Related U.S. Application Data
(60) Provisional application No. 60/715,476, filed on Sep. 9, 2005.

(51) Int. Cl. A62B 7/10

(52) U.S. Cl. 128/201.25; 128/204.15

(57) ABSTRACT

A breathing apparatus provides circulated air within a hood surrounding a user's head and utilizes active scrubbing to remove carbon dioxide from the air in the hood. The breathing apparatus includes a heat sink that provides cooling to the circulated air. A method for cooling air circulated within a breathing apparatus includes operating an air pump to circulate the air so that the air comes into contact with a heat sink to which the air releases heat. In an embodiment, a compressed oxygen gas cylinder releasing the compressed oxygen acts both as a driver for a Venturi device that operates as an air pump and as a heat sink.

### CROSS REFERENCE TO RELATED APPLICATIONS

This application claims priority to and the benefit of U.S. Provisional Patent Application Ser. No. 60/715,476 filed Sep. 9, 2005, the entire disclosure of which is herein incorporated by reference.

### GOVERNMENT SPONSORED RESEARCH

A portion of the development of this invention was supported by U.S. ARMY RDECOM ACQUISITION CENTER through Contract No. W91CRB-06-0019. Therefore, the United States Government may have certain rights with regard to this invention.

### BACKGROUND OF THE INVENTION

1. Field of the Invention

This invention relates to a self contained breathing apparatus, and more particularly to a breathing apparatus comprising a hood surrounding a user's head and sealed about the user's neck, and for which the internal atmosphere is actively scrubbed and enhanced with oxygen.

2. Description of Related Art

Concerns over the threat of a terrorist's use of chemical, biological, radiological, or nuclear (CBRN) weapons has prompted an increased interest in the effectiveness of breathing apparatuses that can be used in an emergency to allow emergency personnel to operate in a contaminated area, or to allow for protection of occupants during the evacuation of a contaminated building or mass transit vehicle.

While some types of breathing apparatuses already exist, they often fall short of meeting desired performance characteristics. Revised standards recently developed by the National Institute for Occupational Safety and Health (NIOSH) for protective breathing apparatuses for use in countering CBRN threats have created increased performance demands, particularly related to maximum carbon dioxide (CO₂) levels and minimum oxygen flow rates, that cannot be met by most existing breathing apparatuses, NIOSH requires a minimum oxygen flow rate of three liters per minute (3 lpm) for the entire fifteen minute specified duration of use of the apparatus, and a maximum CO₂ level of 3%.

Passive scrubbing techniques are generally unable to maintain the NIOSH required CO₂ level of 3%. Active scrubbing techniques are known to be more effective in removing CO₂ Many active scrubbers, however, require the user to breathe directly through a cartridge containing a CO₂ adsorbent chemical. Directly scrubbed respiration requires an interface between the user and the scrubber, such as a mouth bit with a nose clip or a mouth and nose cup. Many people are uncomfortable or physically unable to use a mouth bit or cup due to facial hair or the like and such a device greatly reduces the user's ability to communicate, which can be particularly problematic in emergency situations, Additionally, breathing directly through the adsorbent cartridge increases the work of breathing

Many emergency breathing apparatuses include a hood that encloses a user's head and which not only aids in protecting sensitive areas about the face and within the respiratory system, but also allows the elimination of any mouth bit or cup. A problem particularly associated with such hoods, however, is the elevated temperature within such a hood during use, Exhaled air is raised in temperature due to internal body temperature. Additionally, a users head radiates body heat that is absorbed by the air in the hood. Further chemical scrubbers often utilize exothermic reactions adding more heat to the air within the hood. Not only may such increased temperature be uncomfortable, but also when the air being breathed is heated, the result can be severe impairment in overall functioning of the user wearing the breathing apparatus, and worse, difficulty in breathing and even respiratory burns.

### SUMMARY OF THE INVENTION

The following summary of the invention is provided to give the reader a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented in a later section.

At least in part due to the problems discussed in the Background section and other problems in the art, described herein is a breathing apparatus providing breathable air within a hood surrounding a user's head, The apparatus utilizes active scrubbing to remove carbon dioxide by circulating the air out of the hood and through a housing containing purification elements. The housing also includes a heat sink that is able to cool the circulated air.

Also described herein is a method for cooling air circulated within a breathing apparatus, the method including operating an air pump to circulate the air within a breathing apparatus so that the circulated air comes into contact with a heat sink to which the air releases heat. In an embodiment, a compressed oxygen gas cylinder releasing oxygen acts as a driver for a Venturi device that functions as an air pump and acts as a heat sink.

### BRIEF DESCRIPTION OF THE DRAWINGS

FIG. 1 provides a perspective view of an embodiment of a breathing apparatus as worn by a user.

FIG. 2 provides a cross-sectional view of a housing assembly of an embodiment of a breathing apparatus.

FIG. 3 provides a cut-away perspective view of an alternate embodiment of a housing assembly.

### DETAILED DESCRIPTION OF PREFERRED EMBODIMENTS

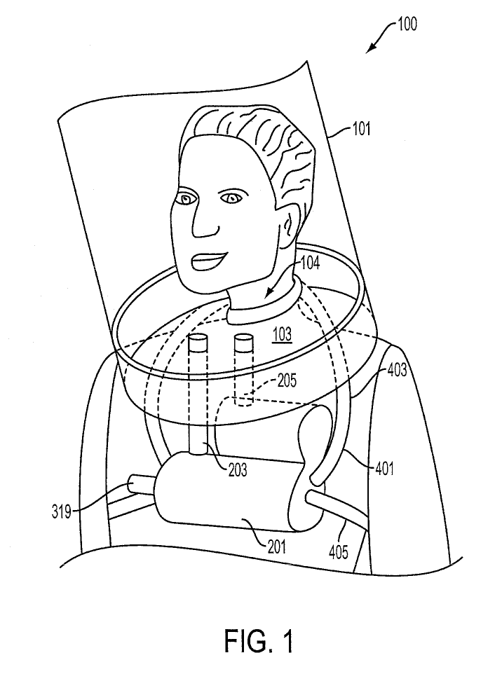

An embodiment of a breathing apparatus (100) is shown in FIG. 1, and generally comprises a hood (101) and a housing (201). The hood (101) surrounds the user's head and contains a breathable atmosphere. The housing (201) holds elements that function to provide air purification and oxygen enrichment for the atmosphere within the hood (101), thereby providing support for the respiration of the user wearing the hood (101), Such a breathing apparatus (100) is designed to provide protection from dangerous external environments, such as are presented by, though not limited to, smoke or fire, or chemical, biological, radiological or nuclear hazards, that might otherwise negatively impact any or all of the biological and physiological functions central to a user's head, such as sight and respiration and so many other bodily functions that can be detrimentally impacted by inhaled hazards.

An aspect of the apparatus (100) is a hood (101) that is large enough to surround a person's head. The hood (101) is constructed at least in part of a transparent or translucent material through which the user can see when wearing the hood (101). The hood (101) includes a neck seal subassembly (103), which provides an opening (104) through which a user's head is moved when donning the hood (101). In an embodiment, the neck seal subassembly (103) functions like an elastomeric membrane allowing the opening (104) to expand to allow a user's head into the hood (101) and then to contract to seal snuggly around the user's neck, essentially separating the environment inside the hood (101)—an internal volume in which resides the user's head—from the environment outside the hood (101).

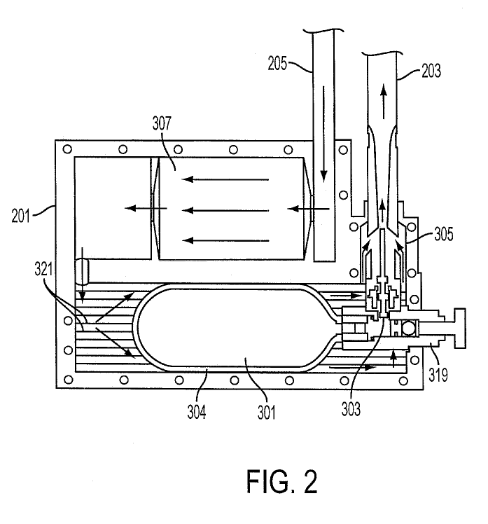

Another aspect of the apparatus (100) is an enclosed housing (201), In an embodiment, such as is shown in FIG. 2, the housing (201) includes multiple internal chambers. As shown in FIG. 2, the chambers of the housing (201) reside internal to the housing (201), and are connected one to another to allow air flow therebetween through the housing (201), In an embodiment, the chambers are connected so as to create a flow path having a beginning and an end, thereby allowing generally unidirectional air flow through the housing (201) in the direction of such flow path from beginning to end. In an embodiment, the chambers of such a housing (201) are connected to the internal volume of a hood (101) at both the beginning and end of such flow path. As shown in FIG. 1, in an embodiment, such connection is made via two hoses, one hood output hose (205) connecting the internal hood volume to the beginning of the housing flow path, and one hood input hose (203) connecting the end of the housing flow path to the internal hood volume. Such a connection between the housing (201) and the hood (101) creates a closed volume comprising the internal hood volume, the housing chamber volume, and the hose volumes, and further creates a self contained circulation path for air to move from the internal volume of the hood (101), through the chambers of the housing (201), and back to the hood (101). Through such closed volume, along such circulation path, air can flow in a recirculating manner. In this regard, the hood output hose (205) provides a path for air in the internal hood volume to exit the hood (101) and to enter the chambers of the housing (201), and the hood input hose (203) provides a path for air to exit the chambers of the housing (201) and enter the internal hood volume.

FIG. 2 shows a cross-sectional view of an embodiment of a housing (201) having a generally unidirectional flow path depicted using a series of arrows pointing into the housing (201) from output hose (205), pointing from one chamber to another within the housing (201), and pointing from an air pump (305) into the input hose (203). In this embodiment, elements within the chambers of the housing (201) include a scrubber (307), an oxygen source (301), and an air pump (305). In the embodiment shown in FIG. 2, the air pump (305) is a Venturi device, which is used to pull air from the chambers of the housing (201) and push this air into the internal hood volume through input hose (203). This air pump (305) sets up the recirculation of air within the closed system that is comprised by the breathing apparatus (100).

In the embodiment shown in FIG. 2 the Venturi device is powered by the jet stream output from a compressed gas cylinder (304) that is an oxygen enrichment source (301). While in other embodiments, other oxygen enrichment sources (301), such as solid state chemical oxygen generators, are used, the depicted embodiment utilizes a compressed gas cylinder (304). The cylinder (304) of compressed oxygen gas is attached to a regulator (303) for controlling release of oxygen from the cylinder (304) through regulation of the flow rate thereof. To start the flow of oxygen from the cylinder (304) prior to donning the hood (101), a user operates an actuator (319), which in an embodiment is a spring biased pin that punctures a gasket of the cylinder (304) to release the compressed gas contained therein.

In the embodiment shown in FIG. 2, the cylinder (304) is mounted within a chamber of the housing (201) having an internal rib structure. The ribs (321) run parallel to the direction of the flow path (as marked by arrows in FIG. 2) within the housing (201). While the cylinder (304) is securely held in place by contact with the tops of the ribs (321), the troughs between ribs (321) provide channels for air flow to continue through this chamber around the cylinder (304). In other embodiments, other structures, such as fingers, provide secure positioning for the cylinder (304) and allow air flow around the cylinder (304). In an embodiment, the cylinder (304) initially is pressurized to about 3000 psi, and contains about 60 liters of pure oxygen gas. In an embodiment, the regulator allows an oxygen flow rate in the range of about two liters per minute to about six liters per minute, and more preferably in the range of about three liters per minute to about four liters per minute.

As mentioned above, in an embodiment the air pump (305) is a Venturi device, the operation of which is based upon the flow of oxygen out of the pressurized cylinder (304). As this flow of oxygen passes through the Venturi device, the decreased pressure therein draws air from around the cylinder (304) into the flow within the Venturi device, inducing a mixing of recycled air with the oxygen released from the cylinder (304). This drawing of air into the Venturi device for mixing with the pure oxygen from the cylinder (304) is the source of a flow amplification defined by the ratio between the oxygen gas flow rate entering the Venturi device and the mixed gas flow rate exiting the Venturi device. In a preferred embodiment, the Venturi device creates a flow amplification of approximately 13 to 1 (i.e., 4 lpm oxygen flow entrains 52 lpm of air). In this way, recycled air pulled from the internal hood volume and through the housing (201) is mixed with oxygen ejected from the cylinder (304) and the mixture is provided through input hose (203) into the internal hood volume and thereby back to the user.

While the air pump (305) is operating, air from inside the hood (101) is pulled through output hose (205) into the housing (201). In the course of the air's path through the housing (201), the air passes through one or more purification devices, which may include but is not limited to particulate filtration or chemical purification, such as catalytic oxidation or adsorption. In the embodiment shown in FIG. 2, air purification occurs as a result of air passage though a purification cartridge (307), which removes carbon dioxide from the air. In alternate embodiments the cartridge (307) may also remove other unwanted components of the air, including moisture. The cartridge (307) in this embodiment comprises a solid chemical substrate that chemically adsorbs or otherwise separates carbon dioxide from the air drawn from the internal hood volume. Carbon dioxide must be removed because of the constant enrichment with carbon dioxide of the air within the internal hood volume due to the user's respiration. In alternate embodiments, the cartridge (307) is filled with granular material, sheet material, or material in another form. In a preferred embodiment, an ExtendAir® Lithium HR CO₂ adsorbent cartridge manufactured by Micropore, Inc. is utilized as the filter cartridge (307). ExtendAir® cartridges comprise a relatively new form of lithium hydroxide adsorbent that has been formed into sheets rather than being provided as traditional granules. The sheet adsorbent is formed to include ribs such that when the sheet is rolled the ribs create channels between the sheets through which air can flow. ExtendAiri® cartridges provide more efficient carbon dioxide scrubbing and therefore last longer than an equivalent amount of granular adsorbent, as well as generating lower adsorption reaction temperatures, therefore adding less heat to the air passing through the cartridge (307).

Another aspect of the embodiment shown in FIG. 1 is a harness (401) that hooks about the user's neck and chest to provide support for the housing (201) near the user's head and therefore near the hood (101), The harness (401) in the depicted embodiment is designed to support the housing (201) on the front of the user's torso utilizing two straps, a neck strap (403) and a torso strap (405). This design allows for hands free operation and for reduced encumbrance to the activities of the user, since the housing (201) is held closely to the user's chest. In other embodiments, other harness configurations are used to support the housing (201) at a convenient location relative to the user, including in various embodiments, near the user's waist and on the user's back.

The apparatus (100) will generally be stored prior to use in a vacuum sealed barrier pouch that is intended to be opened only at the time the apparatus (100) will be used, such as when needed to be donned quickly in an emergency. Such sealed storage maintains the cleanliness of the apparatus (100) and the functional capabilities of the purification device, such as cartridge (307), For instance, without a sealed barrier about the apparatus (100), carbon dioxide from the ambient atmosphere could deplete the ability of the purification device to remove carbon dioxide from the air within the hood (101) when being worn by a user.

To use the apparatus (100) shown in FIG. 1, a user will generally remove the device from the vacuum-sealed barrier pouch by tearing open the vacuum-sealed pouch and removing the apparatus (100). In another step, the user places the neck strap (403) around the back of the user's neck allowing the housing (201) to rest on the user's chest. The torso strap (405) is secured around the user's back and onto the opposite side of the housing (201), This configuration allows for all strap connections to be maintained in front of the user for easy control, as well as placing the mass of the housing (201) close to the user's chest, a relatively comfortable and convenient location.

The user operates an actuator (319), a portion of which is accessible external to the housing (201). Operation of the actuator (319) begins the flow of oxygen through a regulator (303) and into the hood (101). The user will generally place both hands inside the neck seal subassembly (103) opening (104) with palms facing each other, expand the opening (104) by spreading apart these hands, and slide the opening (104) over the user's head so the user's head is positioned inside the hood (101). The user then removes the user's hands from the opening (104) allowing the neck seal subassembly (103) to seal securely around the user's neck. The user may adjust the harness (401) as needed for comfort and mobility.

The user can breathe normally inside the hood (101), which generally will gradually start to inflate, since the user's consumption of oxygen is generally less than the volume of oxygen added from the oxygen source (301) in any given time period. Too, so that the addition of oxygen to the internal volume of the hood (101) does not result in too great an internal pressure, there is, in an embodiment, a pressure relief valve on the hood (101), which relieves internal pressure to the ambient atmosphere outside the hood (101) when the pressure inside the hood (101) reaches a preset threshold value. In another embodiment, pressure internal to the hood (101) is released through the neck seal subassembly (103), which seal automatically opens momentarily upon the internal hood pressure reaching a threshold value, thereby releasing some of the pressure before the seal automatically closes again.

When the oxygen source (301) is depleted, the hood (101) will start to deflate indicating that the hood (101) needs to be removed or a new source of oxygen started, By the time of such a deflation, if no new oxygen source is available for the hood (101), the user should have moved to an area with a non-hazardous atmosphere so that the user may safely remove the apparatus (100).

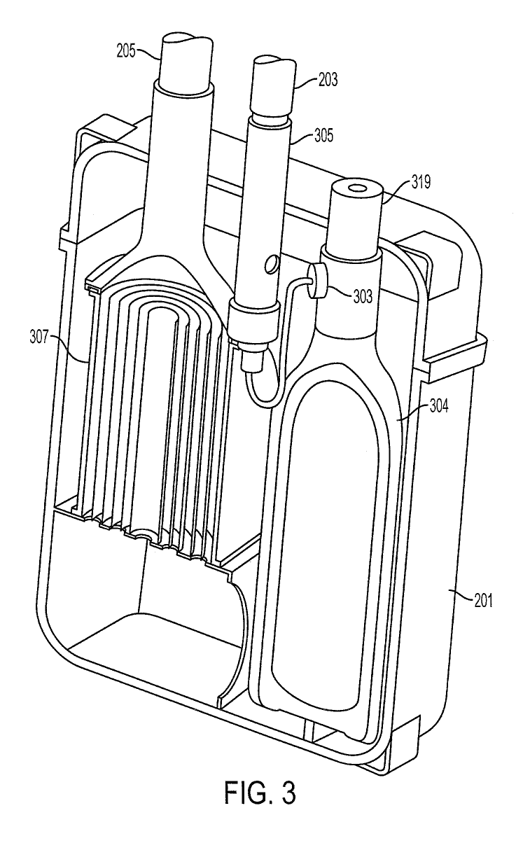

In an embodiment such as shown in either FIG. 2 or FIG. 3, when oxygen flow commences, generally upon initial operation of the actuator (319), this flow of oxygen from cylinder (304) is plumbed into the Venturi device (305) in a direction relative to the geometry thereof so as to produce a Venturi effect therein, which draws additional air into the Venturi device from within the housing (201). The circulated air flow drawn into the air pump (305) by the Venturi effect is deliberately engineered to flow adjacent to the compressed oxygen cylinder (304), in an embodiment, as a result of the arrangement of elements within the housing (201). Such deliberately engineered air flow places the flowing air in contact with the exterior surface of the cylinder (304). Contact between the circulating air and the cylinder allows heat to be removed from the air to the cylinder (304). In this way the cylinder (304) operates as a heat sink. In other embodiments, other devices, such as a Peltier device, act as a heat sink to remove heat from the flowing air.

In an embodiment such as is shown in either of FIG. 2 or 3, the removal of heat from the flowing air occurs because the cylinder (304) is cooled when the compressed gas inside of the cylinder (304) is released, as is predicted by the generalized ideal gas law. Notably, as the pressure in the cylinder (304) decreases due to release of oxygen therefrom, the temperature of the oxygen in the cylinder (304) decreases, thus, so does the temperature of the cylinder (304), itself, due to the physical interaction between the cylinder (304) and the oxygen contained therein. Therefore, as the oxygen leaves the pressurized cylinder (304) reducing the pressure in the cylinder (304), the external surface of the cylinder (304) will cool. This is particularly noticeable if the material of which the cylinder (304) is constructed is effective at conducting heat, such as if it is constructed of metal.

As for embodiments such as are shown in either of FIG. 2 or 3, prior to flowing around the cylinder (304), the recirculated air is drawn through the purification cartridge (307) or scrubber containing a chemical carbon dioxide adsorbent. The chemical process for removing carbon dioxide is generally exothermic, thus heating the air considerably, In addition, heat is added to the air in the hood (101) as a result of the user's body temperature, both by radiation from the user's head and convection due to the user's respiration. This increased air temperature can be problematic during use of the apparatus (100), since providing hot air to a user can injure the user and also can cause exhaustion more quickly. However, in an embodiment, heated air is cooled by passage over the cylinder (304) as described above, thereby moderating the effect of heating by the scrubber and the user's body, Further moderation of the added heat is obtained as a result of the mixing between the recirculated air and the pure oxygen released from the cylinder (304), which oxygen is cooled through depressurizing release from the cylinder (304). In this way, i.e., interaction of recirculated air with the cooled cylinder (304) and the cooled oxygen, at a minimum, the temperature in the hood (101) is maintained lower or is increased more slowly than if such cooling did not occur. Furthermore, the cooling effect provided by the cooled cylinder (304) can also condense and thereby remove water vapor from the air.

To summarize the movement of the air within the apparatus (100) shown in FIG. 1 as driven by the air pump (305), which, in an embodiment as described here, includes the purification and pumping elements of the embodiments shown in FIG. 2 or 3: the user's exhaled air is drawn out of the hood (101) and into the housing (201) via outlet hose (205). In the housing (201), the exhaled air is then drawn through the purification cartridge (307) where carbon dioxide is adsorbed chemically, with heat being generated and transferred to the air as an undesirable product of the reaction. The scrubbed air is drawn over the dispensing oxygen cylinder (304), in an embodiment through channels formed by ribs (321). Passage of the air over the cylinder (304) allows the cylinder (304) to absorb heat, aided by the endothermic reduction in pressure of the gas in the cylinder (304) as such gas is released therefrom In an embodiment, the cooled cylinder (304) will also condense residual moisture vapor from the air. The cylinder (304) supplies cool, supplementary oxygen to the air flow and thereby provides the motive flow to produce the Venturi effect through the air pump (305). The oxygen and recycled air mixture are directed back to the hood (101) from the housing (201) through inlet hose (203), This closed loop system maintains sufficiently low internal carbon dioxide levels, sufficiently high oxygen levels, and a moderate temperature within the hood (101) so as to produce a relatively comfortable environment for the user. Further, because exhaust air is reused, unused oxygen is preserved in the recirculating flow, thereby increasing the length of time the hood (101) can be used.

In an embodiment, such as is shown in FIG. 3, this flow traverses a flow path that is generally vertically oriented. That is, in an embodiment, the housing (201) shown in FIG. 3 is designed to be positioned under the hood, as is the housing (201) shown in FIG. 1. The flow path in such an embodiment is such that air travels generally linearly down out of the hood (101) into the housing (201), through the cartridge (307), to the bottom of the flow path before generally reversing direction to travel up past the cylinder (304), through the Venturi device (305) and into the hood (101). As shown in FIG. 3, in an embodiment, the cylinder (304) resides within a fairly open, unobstructed chamber within the housing (201), allowing for a generally unobstructed flow path past the cylinder (304), especially as compared to the embodiment with ribs (321) as shown in FIG. 2.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A breathing apparatus for providing a user with a breathable atmosphere, such breathable atmosphere being generally isolated from a potentially hazardous external environment, said apparatus comprising:
a hood capable of surrounding a user's head, said hood having an internal volume therein;
a housing enclosing a housing volume and having an inlet to and an outlet from said housing volume, said inlet and outlet connected to said internal volume of said hood so as to create a recirculating flow path from said internal volume of said hood, through said housing volume, and back to said internal volume of said hood, said flow path being generally isolated from an environment external to both of said hood and said housing;
an air pump connected to said housing volume and capable of circulating air though said flow path;
an oxygen source; and
a heat sink adjacent to a portion of said flow path capable of absorbing heat from air circulating in said flow path.

2. The breathing apparatus of claim 1 wherein said air pump comprises a Venturi device.

3. The breathing apparatus of claim 1 wherein said housing volume includes an air purification device capable of removing carbon dioxide from air in contact therewith.

4. The breathing apparatus of claim 1 wherein said oxygen source is a compressed gas cylinder.

5. The breathing apparatus of claim 4 wherein said heat sink comprises said compressed gas cylinder.

6. The breathing apparatus of claim 5 wherein said compressed gas cylinder has a heat absorbing capacity that is enhanced by said compressed gas cylinder being opened so as to release compressed gas.

7. The breathing apparatus of claim 6 wherein said air pump comprises a Venturi device having at least one inlet opening therein through which said Venturi device can draw air from said housing to recirculate said air through said flow path; and wherein said compressed gas cylinder is connected to said Venturi device in such a manner that gas released from said cylinder is directed through said Venturi device to create a Venturi effect.

8. The breathing apparatus of claim 4 further comprising a carbon dioxide scrubber;
wherein said flow path is defined by a generally vertical arrangement of components within said housing, thereby requiring only one reversal of flow direction near the bottom of said flow path, such that recirculated air travels down out of said hood into said housing, down through said scrubber to the bottom of said flow path, and generally reverses direction to travel up past said cylinder and up into said hood;
wherein said cylinder is positioned within a generally open chamber within said housing, such that said portion of said flow path adjacent to said cylinder is generally unobstructed.

9. The breathing apparatus of claim 1 wherein said hood is constructed in part of a pliable, transparent material.

10. A method for cooling air that is recirculated within a breathing apparatus, said method comprising the steps of:
providing a breathing apparatus comprising:
a hood having an internal volume and being of sufficient size to surround a user's head;
a housing enclosing a housing volume, said housing volume connected to said internal volume of said hood to allow for circulation between said housing volume and said hood internal volume;
a compressed gas cylinder at least a portion of the external surface of which is adjacent to said housing volume; and
a Venturi device joining said housing volume to said hood internal volume, said Venturi device having a flow channel with a constriction,
opening said cylinder to release said compressed gas into said constriction, thereby cooling said cylinder;
operating said Venturi device utilizing said released gas to pull air from said housing volume through said Venturi device, thereby recirculating air through said housing volume and said hood internal volume; and
transferring heat between said recirculated air and said cooled cylinder in order to cool said recirculated air.

11. The method of claim 10 wherein said released gas is oxygen flowing at a rate of at least one liter per minute.

12. The method of claim 11 wherein said oxygen gas is flowing at a rate in the range of about three liters per minute to about five liters per minute.

13. The method of claim 11 wherein said oxygen gas is flowing at a rate of about four liters per minute.

14. A breathing apparatus for providing a user with a breathable atmosphere that is generally isolated from a potentially hazardous external environment, said apparatus comprising:
a means for essentially isolating from an external environment a first volume about a user's head, said volume comprising breathable air;
a means for removing carbon dioxide from said air;
a means for adding oxygen to said air; and
a means for cooling said air.

15. The breathing apparatus of claim 14 further comprising:
a means for circulating said air out of and back into said first volume;
wherein said means for cooling removes heat from said air while said air is being circulated out of and back into said first volume.

16. The breathing apparatus of claim 15 wherein said means for cooling comprises a heat sink having a cooling surface exposed to said air as said air is circulated by said means for circulating.

17. The breathing apparatus of claim 16 wherein said heat sink is a compressed gas cylinder.

18. The breathing apparatus of claim 17 wherein said cylinder is open and releasing gas.
